(19) United States
(12) Patent Application Publication
(10) Pub. No.: US 2017/0171270 A1
(43) Pub. Date: Jun. 15, 2017

(54) METHOD AND ELECTRONIC DEVICE FOR CONTROLLING VIDEO PLAYING

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Xiang QU, Beijing (CN)

(21) Appl. No.: 15/242,410

(22) Filed: Aug. 19, 2016

Related U.S. Application Data
(63) Continuation of application No. PCT/CN2016/088941, filed on Jul. 6, 2016.

(30) Foreign Application Priority Data
Dec. 14, 2015 (CN) 201510924405.9

(51) Int. Cl. H04L 29/06; H04L 29/08

(52) U.S. Cl. CPC H04L 65/4092; H04L 67/42; H04L 67/10

(57) ABSTRACT

The present disclosure discloses a method and electronic device for controlling video playing. The method includes: receiving a control instruction inputted by a user for a projection device and transmitting the control instruction to a network server; searching a projection device synchronously bound to the intelligent terminal currently and sending the control instruction to the projection device after receiving the control instruction, by the network server, such that the projection device controls video playing according to the control instruction after receiving the control instruction, wherein the intelligent terminal is connected to the network server via network, and the network server is connected to the projection device via network.

### CROSS REFERENCE TO RELATED APPLICATIONS

The present application is a continuation of international application No. PCT/CN2016/088941 filed on Jul. 6, 2016, and claims priority to Chinese Patent Application No. 201510924405.9 entitled “METHOD AND SYSTEM FOR CONTROLLING VIDEO PLAYING”, filed in State Intellectual Property Office on Dec. 14, 2015, the entire contents of all of which are incorporated herein by reference.

### TECHNICAL FIELD

The present disclosure relates to the field of multimedia control, and in particular, to a method and electronic device for controlling video playing.

### BACKGROUND

With developments on computer technology and network technology, an increasing number of household appliances are connected to network and intelligently controlled. Particularly, a gradually prevalent network TV in recent time, by being connected to Internet, may request a video file provided by a video website online, such that a user can watch the latest programme on a large screen. Compared with playing the video by intelligent terminals such as computer, mobile phone and the like, a smart TV has a large-sized screen and better sound effect, and may provide a preferable watching experience.

However, the existing smart TV can be usually operated in local only by a remote control device or touch screen, and cannot be interacted with other intelligent terminals. Due to inconvenient operation, it is difficult to implement functions such as video request and posting comment on the smart TV.

### SUMMARY

In view of this, an object of the present disclosure is to provide a method and electronic device for controlling video playing, which implements a process of video playing in which an intelligent terminal remotely controls a projection equipment.

According to a first aspect of the present disclosure, based on the above object, an embodiment of the present disclosure provides a method for controlling video playing, including:

receiving a control instruction inputted by a user for a projection device, and transmitting the control instruction to a network server; by the network server, searching a projection device synchronously bound to the intelligent terminal currently and sending the control instruction to the projection device after receiving the control instruction, such that the projection device controls video playing according to the control instruction after receiving the control instruction,

wherein the intelligent terminal is connected to the network server via network, and the network server is connected to the projection device via network.

According to a second aspect of the present disclosure, there is provided a non-volatile computer storage medium which is stored with computer executable instructions, and the computer executable instructions are configured for performing any one of the above methods for controlling video playing.

According to a third aspect of the present disclosure, there is provided an electronic device including one or more processors and a memory, wherein, the memory is stored with instructions executable by the one or more processors, and the instructions are set to perform any one of the above methods for controlling video playing.

It should be understood that, the above general description and any detailed description illustrated hereinafter are merely exemplary and explanatory, without limiting the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a schematic flowchart illustrating an embodiment of a method for controlling video playing provided by the present disclosure;

FIG. 2 is a schematic flowchart illustrating another embodiment of a method for controlling video playing provided by the present disclosure;

FIG. 3 is a timing diagram illustrating yet another embodiment of a method for controlling video playing provided by the present disclosure;

FIG. 4 is a timing diagram illustrating an optional embodiment of a method for controlling video playing provided by the present disclosure;

FIG. 5 is a system module diagram illustrating an embodiment of a system for controlling video playing provided by the present disclosure;

FIG. 6 is a schematic structure diagram of hardware of an electronic device for controlling video playing of video provided by an embodiment of the present disclosure.

### DETAILED DESCRIPTION

In order to make the objects, technical solutions and advantages of the present disclosure more apparent, the present disclosure will be further illustrated in details below in conjunction with the specific embodiments and the drawings.

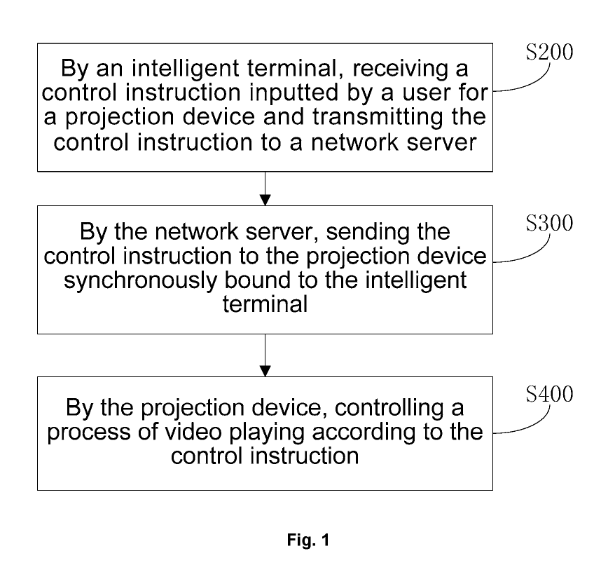

FIG. 1 is a schematic flowchart illustrating an embodiment of a method for controlling video playing provided by the present disclosure. As shown in FIG. 1, the embodiment of the present disclosure provides a method for controlling video playing applied to a system including an intelligent terminal, a network server and a projection device, wherein the intelligent terminal and the projection device are both connected to the network server via network (the network on the whole is telecommunication network, of which the specific representation may be mobile network, wire network, and the like), and the method includes the following steps.

In step S200, the intelligent terminal receives a control instruction inputted by a user for a projection device, and transmits the control instruction to the network server.

Optionally, after receiving a touch control operation of the user, the intelligent terminal searches a control instruction corresponding to the touch control operation in a preset list of control instructions, and transmits the searched control instruction to the network server. The specific method for the touch control operation corresponding to the control instruction will be exemplified hereinafter.

The intelligent terminal is an intelligent device having a network connection function, including computer, smart mobile phone and tablet computer.

In step S300, after receiving the control instruction, the network server searches a projection device synchronously bound to the intelligent terminal currently and sends the control instruction to the projection device.

The projection device is an intelligent projection device having a network connection function, including smart TV and network projector.

The synchronous binding means that the intelligent terminal and projection device are bound together in advance at the network server. After receiving the control instruction sent by the intelligent terminal, the network server sends the control instruction to the projection device bound to the intelligent terminal without confirming target again. The specific binding method is described hereinafter.

In step S400, after receiving the control instruction, the projection device controls video playing according to the control instruction.

The above steps S200-S400 implement a process of remotely controlling, by an intelligent terminal, video playing on a projection device via network. Because the method does not implement above control by local communication (for example, local area network based on the same router, Bluetooth, infrared), the method is not limited by distance. In some optional embodiments, a step of switching connection modes between the intelligent terminal and the projection device is further included. Specifically, the intelligent terminal detects the projection device in local network regularly (or at a time of receiving an instruction from the user), and directly sends the control instruction via local network in subsequently sending the control instruction, if detecting the projection device which has created binding relationship with it. When some control instructions required to be carried out by a network server are to be sent, they are still sent via the network server, such that a delay of the control is decreased and the operating speed is further improved.

In some optional embodiments, the step of receiving, by the intelligent terminal, a control instruction inputted by a user for a projection device includes the following steps.

In step S2001, the intelligent terminal displays an operation interface.

In step S2002, the intelligent terminal senses a touch control operation of the user for the operation interface.

In step S2003, the intelligent terminal analyzes the touch control operation to obtain the control instruction for controlling video playing.

By the above steps S2001-S2003, the intelligent terminal provides an interface for performing a touch control operation for the user. In step S2003, the intelligent terminal analyzes the touch control operation of the user to be a univocal control instruction.

The above analyzing step can be completed locally in the intelligent terminal, and can also be further completed by the network server after the touch control operation is sent to the network server, and can yet be finally executed by the projection device after the intact touch control operation is sent to the projection device.

In some optional embodiments, the method further includes the following steps.

The intelligent terminal displays an operation interface including a progress control interface including a progress bar and a progress control block sliding on the progress bar. The step of receiving a control instruction inputted by a user for a projection device and transmitting the control instruction to a network server, by the intelligent terminal, includes the step S210 of sensing an operation of the user and adjusting a progress of video playing on the projection device, by the intelligent terminal, which specifically includes the following sub-steps.

In step S211, a drag operation of the user for the progress control block is sensed.

The drag operation includes: sensing a click operation of the user, and if a position of a contact of the click operation is located in a display range of the progress control block, further sensing a sliding operation of the user on the touch screen, in other words, sensing movement of the contact.

In step S212, a position of the progress control block after the drag operation ends is obtained.

If the contact vanishes, the drag operation is then determined to be end; and if a difference between horizontal distances of a position where the contact vanishes and an initial position of the contact is X, the position of the progress control block is then moved by X (X may be a positive value or a negative value) on the progress bar, which is taken as the position of the progress control block after the drag operation ends.

In step S213, a time point corresponding to the position in a video file is computed.

A left end point of the progress bar is taken as a time start point of the video file, and a right end point of the progress bar is taken as a time end point of the video file. After a position of a midpoint of the progress control block is obtained, a time point of the video file indicated by the progress control block at this moment can be proportionally computed according to a ratio of a distance from the left end point of the progress bar to the midpoint of the progress control block and a distance from the right end point of the progress bar to the midpoint of the progress control block.

In step S214, a progress adjustment instruction including the time point is sent to the projection device via the network server, and the projection device starts playing the video file being played from the time point.

The above S210 and the sub-steps thereof implement a process of controlling, by the intelligent terminal, a progress of video playing on the projection device via network server.

In another optional embodiment, the operation interface includes a barrage sending interface including an input area and a sending area. The step of receiving a control instruction inputted by a user for a projection device and transmitting the control instruction to a network server, by the intelligent terminal, includes step S220 of sensing an operation of the user and sending a barrage, by the intelligent terminal, which specifically includes the following sub-steps.

In step S221, text information inputted by the user are obtained and temporarily stored in the input area.

The input area may be a box, and may also be other forms of specific area. After the user inputs text information, the text information are temporarily stored in the area to make it visible to the user, and may be further modified.

In step S222, the text information stored in the input area is transmitted to the network server when a click of the user on the sending area is detected.

The sending area is configured to sense a sending operation of the user. In other optional embodiments, the sending operation may also be detected by other ways, such as detecting double-click of the user on the input area, or detecting a sliding operation of the user on the input area, and the like.

In step S223, the network server stores the text information as a barrage of a video file being played on the projection device. The barrage includes sending time. When the user watches the video file, the barrage is displayed on the playing interface while the video file is played to the time point.

By the above step S220 and the sub-steps thereof, a function of remotely sending barrage comments is implemented.

Except for functions of remotely controlling a progress of video playing on a projection device and remotely sending barrage comments, the ways for implementing other functions, such as adjusting sound volume, adjusting lightness, adjusting definition, adjusting play speed and the like, are similar. In other words, an operation of the user is obtained at the intelligent terminal, and then a specific control instruction (a concept of the list of control instructions is mentioned in the aforesaid text; the features of these operations of the user can be corresponded to the control instructions one by one, and the features and the control instructions are enumerated in the list of control instructions so as to facilitate determination and search) is determined according to the operation; the control instruction is sent to the projection device via the network server (or a local network), and the projection device adjusts a playing process thereof according to the control instruction.

In one embodiment, the step of receiving a control instruction inputted by a user for a projection device and transmitting the control instruction to a network server, by the intelligent terminal, includes step S230 of sensing an operation of the user and pushing a next video file in a play list to the projection device, by the intelligent terminal, which specifically includes the following steps.

In step S231, a play state of the projection device is obtained if a touch control operation is sensed to be a sweeping operation toward a first direction.

The sweeping operation means that after a click operation on the touch screen is sensed, a start point position of a contact is obtained, movement of the contact is traced then, and a vanishing point position is finally obtained when the contact vanishes. If it is determined to be a sliding operation with a short duration (a specific time threshold can be determined separately) by the start point position, the vanishing point, a movement path and movement time of the contact, it is determined to be “a sweeping operation” defined in the present disclosure. The first direction refers to a direction toward the vanishing point position from the start point position, which is defined by human. Generally, in order to adapt to operating habits of the user, the first direction may be set to be toward right, and may also be set to be other directions.

In step S232, a play link of a next video file in a play list of the intelligent terminal is obtained if the projection device is playing a video file at this moment.

Optionally, if there is no next video file, “already arrived at the end of the play list” or other similar information are prompted to the user at the intelligent terminal.

In step S233, a push instruction including the play link of the next video file is sent to the network server.

Optionally, after receiving the push instruction, the network server obtains the play link in the push instruction, searches a corresponding video file in a video library according to the play link, and sends the video file to the projection device. After starting receiving the video file pushed by the network server, the projection device starts playing the video file.

The above step S230 and the sub-steps thereof implement a function of switching a video on the projection device by the user through operating the intelligent terminal. The user performs the sweeping operation toward the first direction at the intelligent terminal, and the projection device can then play the next video file.

It is required to be illustrated that, all expressions using “a first” and “a second” in the embodiments of the present disclosure are applied for distinguishing two different entities or two different parameters with the same name. It can be seen that, “a first” and “a second” are merely used for convenience in representation, and should not be understood as limiting the embodiments of the present disclosure, which is not further illustrated one by one in subsequent embodiments.

In another embodiment, the step of receiving a control instruction inputted by a user for a projection device and transmitting the control instruction to a network server, by the intelligent terminal, includes step S240 of sensing an operation of the user and pushing a video file being played to the projection device, by the intelligent terminal, which specifically includes the following steps.

In step S241, a play state of the intelligent terminal is obtained at this moment if the touch control operation is sensed to be a sweeping operation toward a second direction.

The definition of the sweeping operation is with the same as that of “a sweeping operation” mentioned above. Generally, in order to adapt to operating habits of the user, the second direction may be set to be upward, and may also be set to be other directions certainly. Further, if the start point position of the contact is determined to be located within an interface of video playing of the intelligent terminal, subsequent steps are performed; otherwise, they are not performed.

In step S242, a push instruction including a play link of a video file is sent to the network server if the intelligent terminal is playing the video file.

In step S243, the network server pushes the video file to the projection device to be played according to the play link.

The ways of specifically executing steps S242 and S243 are similar with those of executing the above steps S232 and S233, and thus they are not further illustrated herein.

Further, in one optional embodiment, the step of pushing the video file to the projection device to be played further includes the following steps.

In step S290, the video playing of the intelligent terminal is stopped and the operation interface is displayed on the intelligent terminal after the video file is successfully pushed to the projection device.

In other words, after the projection device starts playing the video file, a process of video playing of the intelligent terminal is stopped, and an operation interface is displayed on the intelligent terminal, for being operated by the user to remotely control a process of video playing on the projection device.

Further, optionally, the step S290 further includes step S291.

In step S291, a poster of the video file is synchronously displayed on the intelligent terminal.

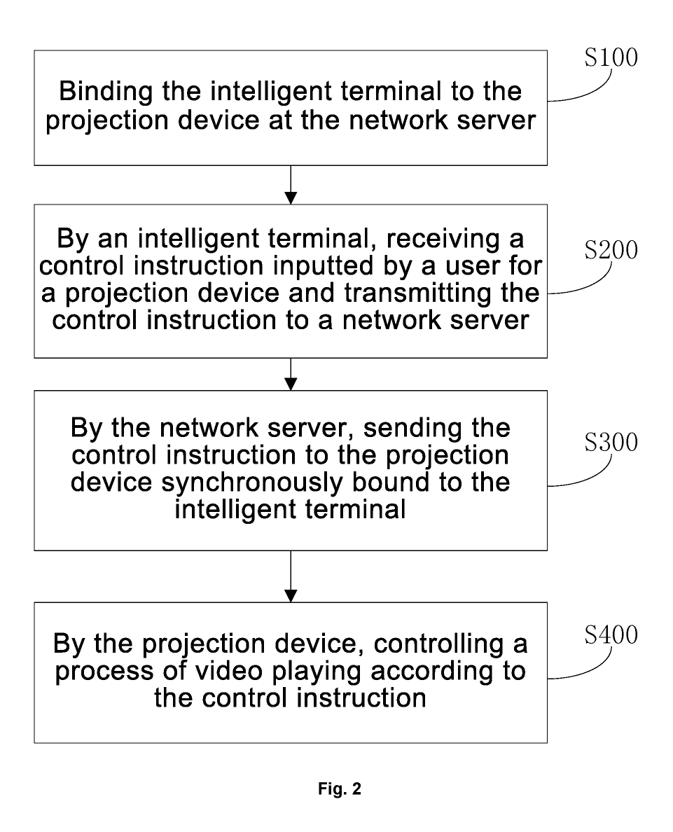

FIG. 2 is a schematic flowchart illustrating another embodiment of a method for controlling video playing provided by the present disclosure. As shown in FIG. 2, in an preferable embodiment, before the step of searching a projection device synchronously bound to the intelligent terminal currently and sending the control instruction to the projection device, by the network server, the method further includes step S100 of binding the intelligent terminal to the projection device at the network server, which specifically includes the following sub-steps.

In step S110, the intelligent terminal sends a binding request including user information of the intelligent terminal and the projection device to the network server.

Specifically, a sending path includes wireless data connection provided by wireless operators or wire network connection provided by broadband operators.

In step S120, the network server compares user information of the intelligent terminal and the projection device, and determines whether users of the intelligent terminal and the projection device are associated users who are users having same user information or having user information associated in advance at the network server.

In step S130, the intelligent terminal is bound to the projection device at the network server if the users of the intelligent terminal and the projection device are determined to be the associated users.

The binding means that when receiving a control instruction sent or an action of pushing a video by the intelligent terminal, the network server directly pushes the control instruction or the video to the projection device bound thereto, without inquiring target to the intelligent terminal. The binding function may be implemented by using corresponding relationship of the physical address or the user name.

In a further embodiment, before step S110, the method further includes an implied step of obtaining, by the intelligent terminal, user information of the projection device.

For example, after receiving the binding instruction, the projection device displays a two-dimension code including user information of the projection device. The intelligent terminal scans the two-dimension code, obtains the user information of the projection device and then adds it to own identification information, or obtains the user information of the projection device in other ways and then adds it to own identification information. When the network server compares the identification information of the projection device with the identification information of the intelligent terminal, if the network server searches out the identification information of the projection device in the identification information of the mobile terminal, it can be proved that the mobile terminal and the projection device are located in the same working space. In other words, the user currently desires to directly control the projection device by the mobile terminal, thus the binding therebetween can be directly implemented.

In a preferable embodiment, step S200 of receiving a control instruction inputted by a user for a projection device and transmitting the control instruction to a network server, by the intelligent terminal, includes the following steps.

In step S201, the intelligent terminal generates a control message including user information of the intelligent terminal and the control instruction.

In step S202, the intelligent terminal transmits the control message to the network server via network according to a network protocol.

In step S300, the network server searches a projection device synchronously bound to the intelligent terminal currently and sends the control instruction to the projection device after receiving the control instruction, which includes steps S301-S303.

In step S301, after receiving a control message, the network server analyzes the control message and obtains user information of the intelligent terminal from the control message.

In step S302, the network server searches a projection device synchronously bound to the terminal of the user according to the user information of the intelligent terminal.

In step S303, the network server transmits the control message to the projection device.

In step S400, the projection device controls video playing according to the control instruction after receiving the control instruction, which includes steps S401 and S402.

In step S401, after receiving a control message, the projection device analyzes the control message and obtains the control instruction from the control message.

In step S402, the projection device controls video playing according to the control instruction.

The above steps explain a specific method of sending the control instruction to the projection device by the intelligent terminal via the network server.

Further, in some optional embodiments, when binding the intelligent terminal to the projection device, the network server generates an identification code and sends it to the intelligent terminal and the projection device respectively.

The step S200 of receiving a control instruction inputted by a user for a projection device and transmitting the control instruction to a network server, by the intelligent terminal, includes step S203.

In step S203, the intelligent terminal adds the identification code to the control message.

The step S400 of controlling video playing according to the control instruction, by the projection device, after receiving the control instruction, includes the following steps.

In step S401, after receiving the control message, the projection device analyzes the control message and obtains an identification code.

In step S402, the projection device compares the identification code with own identification code, and further obtains the control instruction if the identification code is matched with the own identification code, or ignores the control message if the identification code is not matched with the own identification code.

The present embodiment provides a method for verifying security of the control message, which is completed by allocating a separate identification code when the intelligent terminal is bound to the projection device, adding the identification code to the control message, and making the projection device to match the identification code when the projection device receives the control message.

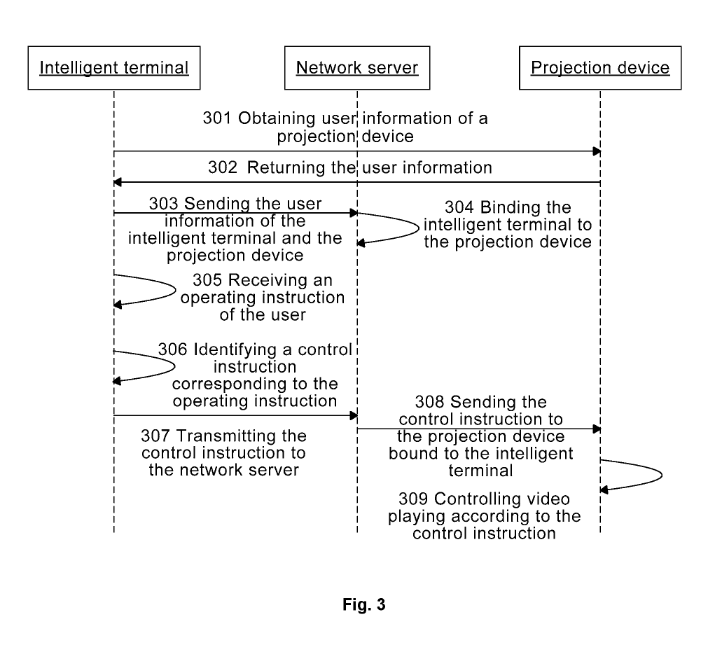

FIG. 3 is a timing diagram illustrating yet another embodiment of a method for controlling video playing provided by the present disclosure. As shown in FIG. 3, the method in the embodiment includes the following steps.

In step 301, an intelligent terminal obtains user information of a projection device.

In step 302, a user device returns the user information to the intelligent terminal.

In step 303, the intelligent terminal sends user information thereof and the user information of the projection device to a network server.

In step 304, the network server binds the intelligent terminal to the projection device according to the user information.

In step 305, the intelligent terminal receives an operating instruction of the user.

In step 306, the intelligent terminal identifies the operating instruction and obtains a control instruction corresponding to the operating instruction.

In step 307, the intelligent terminal sends the control instruction to the network server.

In step 308, the network server sends the control instruction to the projection device bound to the intelligent terminal.

In step 309, the projection device controls its own process of video playing according to the control instruction.

The present embodiment implements a process of binding the intelligent terminal to the projection device at the network server, and based on the binding, further implements that the intelligent terminal identifies an operation of the user, obtains an control instruction, and sends the control instruction via the network server, so as to control a process of video playing on the projection device. The user can connect the projection device to the intelligent terminal anytime and anywhere, and even if they are located in different regions, the user can also remotely control a process of video playing on the projection device.

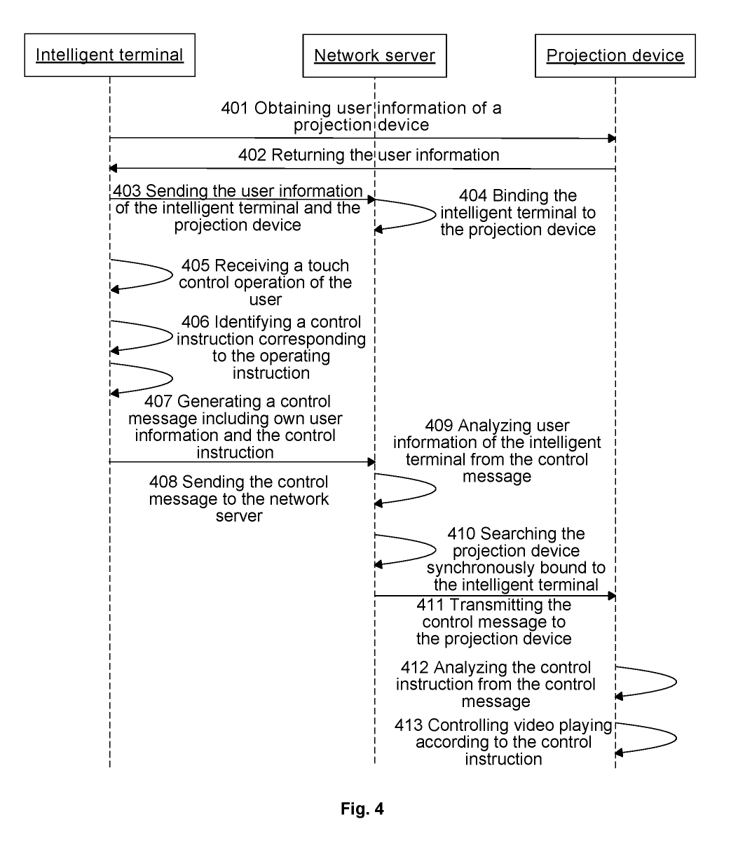

FIG. 4 is a timing diagram illustrating an optional embodiment of a method for controlling video playing provided by the present disclosure. As shown in FIG. 4, the method in the embodiment includes the following steps.

In step 401, an intelligent terminal obtains user information of a projection device.

In step 402, a user device returns the user information to the intelligent terminal.

In step 403, the intelligent terminal sends own user information and the user information of the projection device to a network server.

In step 404, the network server binds the intelligent terminal to the projection device according to the user information.

In step 405, the intelligent terminal receives an operating instruction from the user.

In step 406, the intelligent terminal identifies the operating instruction and obtains a control instruction corresponding to the operating instruction.

In step 407, the intelligent terminal generates a control message including the own user information and the control instruction.

In step 408, the intelligent terminal sends the control message to the network server.

In step 409, the network server analyzes the user information of the intelligent terminal from the control message.

In step 410, the network server searches the projection device synchronously bound to the intelligent terminal.

In step 411, the network server transmits the control message to the projection device.

In step 412, the projection device analyzes the control instruction from the control message.

In step 413, the projection device controls video playing according to the control instruction.

The present embodiment specifically embodies that a control instruction is sent by a control message. If necessary, the control message can further be encrypted, thereby further enhancing security of the whole communication process.

In another embodiment of the present disclosure, there is provided an intelligent terminal, wherein the intelligent terminal is connected to the network server via network and the network server is connected to the projection device via network. The intelligent terminal includes a receiving unit and a transmitting unit.

The receiving unit receives a control instruction inputted by a user for a projection device.

The transmitting unit transmits the control instruction to a network server. The network server searches a projection device synchronously bound to the intelligent terminal currently and sends the control instruction to the projection device after receiving the control instruction, such that the projection device controls video playing according to the control instruction after receiving the control instruction.

In another embodiment, the receiving unit is configured to display an interface of video playing, and further configured to add an operation interface to the interface of video playing, sense a touch control operation of the user for the operation interface, and analyze the touch control operation to obtain the control instruction for controlling video playing.

In an optional embodiment, the operation interface includes a progress control interface including a progress bar and a progress control block sliding on the progress bar. The receiving unit is configured to sense a drag operation of the user for the progress control block, obtain a position of the progress control block after the drag operation ends, and compute a time point corresponding to the position in a video file. The transmitting unit is configured to send a progress adjustment instruction including the time point to the network server.

In an optional embodiment, the operation interface includes a barrage sending interface including an input area and a sending area. The receiving unit is configured to obtain text information inputted by the user, temporarily store the text information in the input area, and transmit the text information stored in the input area to the network server when a click of the user on the sending area is detected.

In a preferable embodiment, the receiving unit senses a touch control operation to be a sweeping operation toward a first direction and obtains a play state of the projection device; and if the projection device is playing a video file at this moment, the receiving unit obtains a play link of a next video file in a play list of the intelligent terminal, and sends a push instruction including the play link of the next video file to the network server; or the receiving unit obtains a play state of the intelligent terminal at this moment if sensing the touch control operation to be a sweeping operation toward a second direction, and sends a push instruction including a play link of a video file to the network server if the intelligent terminal is playing the video file.

In an optional embodiment, the transmitting unit is further configured to stop video playing and display an operation interface after the video file is successfully pushed to the projection device.

In another embodiment, the transmitting unit is further configured to send a binding request including user information of the intelligent terminal and the projection device to the network server.

In a preferable embodiment, the transmitting unit generates a control message including user information of the transmitting unit and the control instruction, and transmits the control message to the network server via network according to a network protocol.

In yet another embodiment of the present disclosure, there is further provided a network server, which includes:

a receiving unit, configured to receive a control instruction sent by an intelligent terminal for a projection device;

a binding unit, configured to search a projection device synchronously bound to the intelligent terminal currently; and

a transmitting unit, configured to send the control instruction to the projection device, such that the projection device controls video playing according to the control instruction after receiving the control instruction,

wherein the intelligent terminal is connected to the network server via network, and the network server is connected to the projection device via network.

It should be particularly illustrated that, the representation of the terminal also includes technical features of “receiving unit” and “transmitting unit”. The transmitting unit of the intelligent terminal has a function similar to the transmitting unit in the present embodiment. However, the “receiving unit” of the intelligent terminal is configured to sense a touch control signal of the user and switch it to a control instruction, while the “receiving unit” of the present embodiment is configured to receive the control instruction sent by the intelligent terminal. They have difference herein.

In another optional embodiment, the receiving unit is configured to obtain, from the intelligent terminal, a progress adjustment instruction including a time point. The transmitting unit is configured to send the progress adjustment instruction to the projection device, and the projection device starts playing a video file being played from the time point.

In another optional embodiment, the receiving unit is configured to obtain text information from the intelligent terminal, and store the text information as a barrage of a video file being played on the projection device.

In a preferable embodiment, the binding unit is further configured to compare user information of the intelligent terminal and the projection device, and determine whether the users of the intelligent terminal and the projection device are associated users who are users having same user information or having user information associated in advance at the network server. The binding unit binds the intelligent terminal to the projection device if determining the users of the intelligent terminal and the projection device to be the associated users.

In another optional embodiment, the receiving unit is specifically configured to receive, from the intelligent terminal, a control message including user information of the intelligent terminal and the control instruction, analyze the control message and obtain the user information of the intelligent terminal from the control message.

The binding unit is configured to search a projection device synchronously bound to the terminal of the user according to the user information of the intelligent terminal.

The transmitting unit is configured to transmit the control message to the projection device, such that the projection device analyzes the control message, obtains the control instruction from the control message and executes the control instruction to control video playing.

In a preferable embodiment, the binding unit is further configured to generate an identification code and send the identification code to the intelligent terminal and the projection device respectively when binding the intelligent terminal to the projection device. The intelligent terminal adds the identification code to the control message before sending the control message, such that the projection device analyzes the control message and obtains the identification code after receiving the control message. The projection device compares the identification code with own identification code, and further obtains the control instruction if the identification code is matched with the own identification code, or ignores the control message if the identification code is not matched with the own identification code.

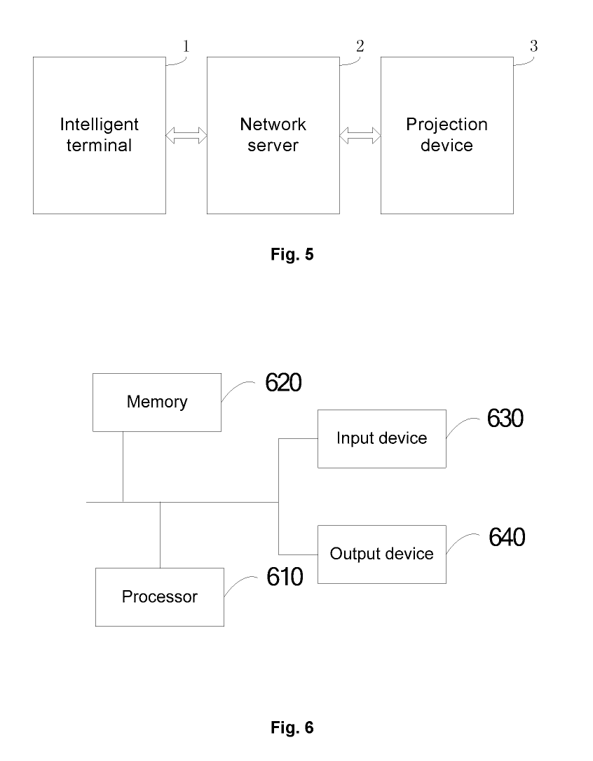

FIG. 5 is a system module diagram illustrating an embodiment of a system for controlling video playing provided by the present disclosure. As shown in FIG. 5, the present disclosure provides an embodiment of a system for controlling video playing. The system includes an intelligent terminal 1, a network server 2 and a projection device 3.

The intelligent terminal 1 is configured to receive a control instruction inputted by a user for a projection device and transmit the control instruction to a network server.

The network server 2 is configured to search a projection device 3 synchronously bound to the intelligent terminal 1 currently and send the control instruction to the projection device 3 after receiving the control instruction.

The projection device 3 is configured to control video playing according to the control instruction after receiving the control instruction.

The intelligent terminal 1 and the projection device 3 are both connected to the network server 2 via network.

In some optional embodiments, the intelligent terminal includes a display unit configured to display an interface of video playing, and an operation interface unit configured to add an operation interface to the interface of video playing, sense a touch control operation of the user for the operation interface, and analyze the touch control operation to obtain a control instruction for controlling video playing.

In some optional embodiments, the operation interface unit is configured to add an operation interface to the interface of video playing, and sense an operation of the user to the operation interface. The operation interface includes a progress control interface including a progress bar and a progress control block sliding on the progress bar.

The operation interface unit is configured to sense a drag operation of the user for the progress control block, obtain a position of the progress control block after the drag operation ends, and compute a time point corresponding to the position in a video file. The operation interface unit is further configured to send a progress adjustment instruction including the time point to the projection device 3 via the network server 2, and the projection device 3 is configured to start playing a video file being played from the time point.

In other optional embodiments, the operation interface includes a barrage sending interface including an input area and a sending area.

The operation interface unit is configured to obtain text information inputted by the user, temporarily store the text information in the input area, and transmit the text information stored in the input area to the network server when a click of the user on the sending area is detected. The network server 2 is configured to store the text information as a barrage of the video file being played on the projection device.

Further, the intelligent terminal 1 further includes a touch sensing unit configured to sense a touch control operation of the user. The touch sensing unit obtains a play state of the projection device 3 if sensing the touch control operation to be a sweeping operation toward a first direction, obtain a play link of a next video file in a play list of the intelligent terminal 1 if the projection device 3 is playing a video file at this moment, and send a push instruction including the play link of the next video file to the network server 2.

Optionally, the intelligent terminal 1 further includes a touch control sensing unit, configured to sense a touch control operation of the user. The touch control sensing unit obtains a play state of the intelligent terminal 1 if sensing the touch control operation to be a sweeping operation toward a second direction, and send a push instruction including a play link of a video file to network server 2 if the intelligent terminal 1 is playing the video file. The network server 2 pushes the video file to the projection device 3 to be played according to the play link.

Further, the intelligent terminal 1 stops video playing and displays an operation interface after the video file is successfully pushed to the projection device 3.

In a preferable embodiment, the intelligent terminal 1 is configured to send a binding request including user information of the intelligent terminal 1 and the projection device 3 to the network server 2. The network server 2 is configured to compare user information of the intelligent terminal 1 and the projection device 3, and determine whether the users of the intelligent terminal 1 and the projection device 3 are associated users who are users having same user information or having user information associated in advance at the network server 2. The network server 2 is further configured to bind the intelligent terminal 1 to the projection device 3 if determining the users of the intelligent terminal 1 and the projection device 3 to be the associated users.

In a preferable embodiment, the intelligent terminal 1 is configured to generate a control message including user information of the intelligent terminal 1 and the control instruction, and transmit the control message to the network server 2 via network according to a network protocol. The network server 2 is configured to analyze the control message and obtain the user information of the intelligent terminal 1 from the control message after receiving the control message, search the projection device 3 synchronously bound to the terminal 1 of the user according to the user information of the intelligent terminal 1, and transmit the control message to the projection device 3. The projection device 3 is configured to analyze the control message, obtain the control instruction from the control message and control video playing according to the control instruction, after receiving the control message.

In another embodiment, the network server 2 generates an identification code and sends the identification code to the intelligent terminal 1 and the projection device 3 respectively when binding the intelligent terminal 1 and the projection device 3. The intelligent terminal 1 adds the identification code to the control message when generating the control message. The projection device 3 analyzes the control message and obtains the identification code after receiving the control message, compares the identification code with own identification code, and further obtains the control instruction if the identification code is matched with the own identification code, or ignores the control message if the identification code is not matched with the own identification code.

An embodiment of the present disclosure further provide a non-volatile computer storage medium, wherein the non-volatile computer storage medium is stored with computer executable instructions which are used to perform any of the methods for controlling video playing in the above embodiments.

FIG. 6 is a schematic structure diagram of hardware of an electronic device for controlling video playing according to an embodiment of the present disclosure. As shown in FIG. 6, the device includes one or more processors 610 and a memory 620, and FIG. 6 illustrates one processor 610 as an example.

The electronic device for controlling video playing may further include an input device 630 and an output device 640.

The processor 610, memory 620, input device 630 and output device 640 may be connected with each other through bus or other ways. FIG. 6 illustrates bus connection as an example.

As a non-volatile computer readable storage medium, the memory 620 may be configured to store non-volatile software program, non-volatile computer executable program and module, such as program instruction/module corresponding to the method for controlling video playing according to the embodiments of the disclosure. By executing the non-volatile software program, instruction and module stored in the memory 620, the processor 610 may perform various functional applications of the server and data processing, that is, achieve the method for controlling video playing according to the above mentioned embodiments.

The memory 620 may include a program storage area and a data storage area, wherein the program storage area may store the operating system and application which are needed by at least one function, and the data storage area may store data which is created according to use of the device for controlling video playing, and the like. Further, the memory 620 may include a high-speed random access memory, and may further include a non-volatile memory, such as at least one of disk memory device, flash memory device or other types of non-volatile solid state memory device. In some embodiments, optionally, the memory 620 may include a memory provided remotely with respect to the processor 610, and such memory may be connected with the device for controlling video playing through network. The examples of the network may include but not limited to Internet, intranet, LAN (Local Area Network), mobile communication network and combinations thereof.

The input device 630 may receive inputted digital or character information, and generate key signal input related to the user settings and functional control of the device for controlling video playing. The output device 640 may include a display device such as a display screen and the like.

The above one or more modules may be stored in the memory 620. When these modules are executed by the one or more processor 610, the method for controlling video playing according to any one of the above embodiments may be performed.

The above product may perform the methods provided in the embodiments of the disclosure, and include functional modules corresponding to these methods and advantageous effects. Further technical details which are not described in detail in the present embodiment may refer to the methods provided according to embodiments of the disclosure.

The electronic device in the embodiment of the present disclosure may be embodied in various forms, including but not limited to:

(1) mobile communication device, characterized in having a function of mobile communication and mainly aimed at providing speech and data communication, wherein such terminal includes: smart phone (such as iPhone), multimedia phone, functional phone, low end phone and the like;

(2) ultra mobile personal computer device, which falls in a scope of personal computer, has functions of calculation and processing, and generally has characteristics of mobile internet access, wherein such terminal includes: PDA, MID, UMPC devices and the like, such as iPad;

(3) portable entertainment device, which can display and play multimedia contents, and includes audio or video player (such as iPod), portable game console, e-book and smart toys and portable vehicle navigation device;

(4) server, which is an device for providing computing service, and constituted by processor, hard disc, memory, system bus and the like, wherein the server has a framework similar to that of a computer, but is demanded for superior processing ability, stability, reliability, security, extendibility and manageability due to high reliable services are desired; and

(5) other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in a place or distributed to a plurality of network units. All or part of modules may be selected as actually required to implement the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk, compact disc and the like, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for controlling video playing, comprising:
at an intelligent terminal:
receiving a control instruction inputted by a user for a projection device, and transmitting the control instruction to a network server; by the network server, searching a projection device synchronously bound to the intelligent terminal currently and sending the control instruction to the projection device after receiving the control instruction, such that the projection device controls video playing according to the control instruction after receiving the control instruction,
wherein the intelligent terminal is connected to the network server via network, and the network server is connected to the projection device via network.

2. The method according to claim 1, wherein the step of receiving, by the intelligent terminal, a control instruction inputted by a user for a projection device comprises:
displaying an operation interface;
sensing a touch control operation of the user for the operation interface; and
analyzing the touch control operation to obtain the control instruction for controlling video playing.

3. The method according to claim 2, wherein the operation interface comprises a progress control interface comprising a progress bar and a progress control block sliding on the progress bar; and the step of receiving a control instruction inputted by a user for a projection device and transmitting the control instruction to a network server, by the intelligent terminal, comprises:
sensing a drag operation of the user for the progress control block, obtaining a position of the progress control block after the drag operation ends, and computing a time point corresponding to the position in a video file; and
sending a progress adjustment instruction comprising the time point to the network server.

4. The method according to claim 2, wherein the operation interface comprises a barrage sending interface comprising an input area and a sending area; and the step of receiving a control instruction inputted by a user for a projection device and transmitting the control instruction to a network server, by the intelligent terminal, comprises:
by intelligent terminal, obtaining text information inputted by the user, and temporarily storing the text information in the input area; and transmitting the text information stored in the input area to the network server, when a click of the user on the sending area is detected.

5. The method according to claim 1, wherein the step of receiving a control instruction inputted by a user for a projection device and transmitting the control instruction to a network server, by the intelligent terminal, comprises:
obtaining a play state of the projection device if the touch control operation is sensed to be a sweeping operation toward a first direction;
obtaining a play link of a next video file in a play list of the intelligent terminal if the projection device is playing a video file at this moment; and
sending a push instruction comprising the play link of the next video file to the network server; or
obtaining a play state of the intelligent terminal at this moment if the touch control operation is sensed to be a sweeping operation toward a second direction; and
sending a push instruction comprising a play link of a video file to the network server if the intelligent terminal is playing the video file.

6. The method according to claim 5, wherein the step of pushing the video file to the projection device to be played further comprises:
stopping video playing and displaying the operation interface after the video file is successfully pushed to the projection device.

7. The method according to claim 1, wherein before the step of searching a projection device synchronously bound to the intelligent terminal currently and sending the control instruction to the projection device, by the network server, the method further comprises a step of binding the intelligent terminal to the projection device at the network server, comprising:
sending, by the intelligent terminal, a binding request comprising user information of the intelligent terminal and the projection device to the network server.

8. The method according to any one of claim 1, wherein the step of receiving a control instruction inputted by a user for a projection device and transmitting the control instruction to a network server, by the intelligent terminal, comprises:
generating, by the intelligent terminal, a control message comprising user information of the intelligent terminal and the control instruction; and
transmitting, by the intelligent terminal, the control message to the network server via network according to a network protocol.

9. A non-transitory computer-readable storage medium, which stores computer-executable instructions that, when executed by an electronic device, cause the electronic device to:
receive a control instruction inputted by a user for a projection device, and transmit the control instruction to a network server, wherein the network server searches a projection device synchronously bound to an intelligent terminal currently and sends the control instruction to the projection device after receiving the control instruction, such that the projection device controls video playing according to the control instruction after receiving the control instruction,
wherein the intelligent terminal is connected to the network server via network, and the network server is connected to the projection device via network.

10. The non-transitory computer-readable storage medium according to claim 9, wherein the step of receiving, by the intelligent terminal, a control instruction inputted by a user for a projection device comprises:
displaying an operation interface;
sensing a touch control operation of the user for the operation interface; and
analyzing the touch control operation to obtain the control instruction for controlling video playing.

11. The non-transitory computer-readable storage medium according to claim 10, wherein the operation interface comprises a progress control interface comprising a progress bar and a progress control block sliding on the progress bar; and the step of receiving a control instruction inputted by a user for a projection device and transmitting the control instruction to a network server, by the intelligent terminal, comprises:
sensing a drag operation of the user for the progress control block, obtaining a position of the progress control block after the drag operation ends, and computing a time point corresponding to the position in a video file; and
sending a progress adjustment instruction comprising the time point to the network server.

12. The non-transitory computer-readable storage medium according to claim 10, wherein the operation interface comprises a barrage sending interface comprising an input area and a sending area; and the step of receiving a control instruction inputted by a user for a projection device and transmitting the control instruction to a network server, by the intelligent terminal, comprises:
by intelligent terminal, obtaining text information inputted by the user, and temporarily storing the text information in the input area; and transmitting the text information stored in the input area to the network server, when a click of the user on the sending area is detected.

13. An electronic device, comprising:
at least one processor; and
a memory communicably connected with the at least one processor,
wherein the memory is stored with instructions executable by the at least one processor, and the instructions are executed by the at least one processor to cause the at least one processor to:
receive a control instruction inputted by a user for a projection device, and transmit the control instruction to a network server, wherein the network server searches a projection device synchronously bound to an intelligent terminal currently and sends the control instruction to the projection device after receiving the control instruction, such that the projection device controls video playing according to the control instruction after receiving the control instruction,
wherein the intelligent terminal is connected to the network server via network, and the network server is connected to the projection device via network.

14. The electronic device according to claim 13, wherein the step of receiving, by the intelligent terminal, a control instruction inputted by a user for a projection device comprises:
displaying an operation interface;
sensing a touch control operation of the user for the operation interface; and
analyzing the touch control operation to obtain the control instruction for controlling video playing.

15. The electronic device according to claim 14, wherein the operation interface comprises a progress control interface comprising a progress bar and a progress control block sliding on the progress bar; and the step of receiving a control instruction inputted by a user for a projection device and transmitting the control instruction to a network server, by the intelligent terminal, comprises:
sensing a drag operation of the user for the progress control block, obtaining a position of the progress control block after the drag operation ends, and computing a time point corresponding to the position in a video file; and
sending a progress adjustment instruction comprising the time point to the network server.

16. The electronic device according to claim 14, wherein the operation interface comprises a barrage sending interface comprising an input area and a sending area; and the step of receiving a control instruction inputted by a user for a projection device and transmitting the control instruction to a network server, by the intelligent terminal, comprises:
by intelligent terminal, obtaining text information inputted by the user, and temporarily storing the text information in the input area; and transmitting the text information stored in the input area to the network server, when a click of the user on the sending area is detected.

17. The electronic device according to claim 13, wherein the step of receiving a control instruction inputted by a user for a projection device and transmitting the control instruction to a network server, by the intelligent terminal, comprises:
obtaining a play state of the projection device if the touch control operation is sensed to be a sweeping operation toward a first direction;
obtaining a play link of a next video file in a play list of the intelligent terminal if the projection device is playing a video file at this moment; and
sending a push instruction comprising the play link of the next video file to the network server; or
obtaining a play state of the intelligent terminal at this moment if the touch control operation is sensed to be a sweeping operation toward a second direction; and
sending a push instruction comprising a play link of a video file to the network server if the intelligent terminal is playing the video file.

18. The electronic device according to claim 17, wherein the step of pushing the video file to the projection device to be played further comprises:
stopping video playing and displaying the operation interface after the video file is successfully pushed to the projection device.

19. The electronic device according to claim 13, wherein before the step of searching a projection device synchronously bound to the intelligent terminal currently and sending the control instruction to the projection device, by the network server, the method further comprises a step of binding the intelligent terminal to the projection device at the network server, comprising:
sending, by the intelligent terminal, a binding request comprising user information of the intelligent terminal and the projection device to the network server.

20. The electronic device according to claim 13, wherein the step of receiving a control instruction inputted by a user for a projection device and transmitting the control instruction to a network server, by the intelligent terminal, comprises:
generating, by the intelligent terminal, a control message comprising user information of the intelligent terminal and the control instruction; and
transmitting, by the intelligent terminal, the control message to the network server via network according to a network protocol.
